(19) United States
(12) Patent Application Publication
(10) Pub. No.: US 2025/0190553 A1
(43) Pub. Date: Jun. 12, 2025

(54) SECURITY METHOD FOR IDENTIFYING KILL CHAINS

(71) Applicant: BRITISH TELECOMMUNICATIONS PUBLIC LIMITED COMPANY, London (GB)

(72) Inventors: Ian HERWONO, London Greater London (GB); Fadi EL-MOUSSA, London Greater London (GB); Luke BOOTH, London Greater London (GB)

(21) Appl. No.: 18/845,199

(22) PCT Filed: Feb. 14, 2023
(86) PCT No.: PCT/EP2023/053631

§ 371 Date: Sep. 9, 2024

(30) Foreign Application Priority Data
Mar. 10, 2022 (GB) 2203348.4

(51) Int. Cl. G06F 21/55

(52) U.S. Cl. CPC G06F 21/554; G06F 21/552; G06F 2221/034

(57) ABSTRACT

A computer implemented security method security method is described, for detecting attacks on a system or network. The method comprises defining a sequence of attack tactics, each attack tactic representing a generalisation of a set of attack techniques, associating one or more attack detection rules with each of the attack techniques, detecting attack events based on the attack detection rules, correlating the detected attack events with the attack tactics based on the attack technique associated with the attack detection rule used to detect the attack events, linking the detected attack events based on one or more criteria, and identifying one or more paths of attack techniques through the sequence in dependence on the linked attack events. The identified paths of attack techniques represent kill chains. The present technique makes it possible to identify new kill chains of known techniques, as well as making it possible to identify high-risk kill chains.

The present invention relates to a security method for identifying kill chains. In particular, embodiments of the present invention relate to a security method and apparatus which seeks to automatically identify high-risk attack paths (kill chains), and to deploy measures to mitigate the risk of such attacks.

Attack paths describe the sequence of steps or activities that an attacker could take to prepare and launch a multi-stage cyber-attack against a system or network. An attacker may employ a specific technique in each step/activity to achieve an interim goal which then allows them to move on to the next step/activity, each time getting closer to the final goal. Knowing the attack paths that an attacker may follow to infiltrate a network or system is very useful for an automated cyber-defence system in order to detect and stop the attack as early as possible and mitigate the impact. In general, each attack path represents a possible cyber kill-chain for gaining privileged access to the network and launching high-impact attacks such as ransomware or stealing of highly sensitive information (for example data exfiltration).

It is known to use identified attack paths to detect multi-stage attacks. One such system is described in EP2979424, the contents of which are hereby incorporated by reference. This works well provided that a multi-stage attack is explicitly covered by (and detectable using) an identified attack path, but if an actual attack uses different stages, then a multi-stage attack can remain undetected—even if most of the stages are present and detectable.

According to a first aspect of the present invention, there is provided a computer implemented security method for detecting attacks on a system or network, the method comprising:
defining a sequence of attack tactics, each attack tactic representing a generalisation of a set of attack techniques;
associating one or more attack detection rules with each of the attack techniques;
detecting attack events based on the attack detection rules;
correlating the detected attack events with the attack tactics based on the attack technique associated with the attack detection rule used to detect the attack events;
linking the detected attack events based on one or more criteria; and
identifying one or more paths of attack techniques through the sequence in dependence on the linked attack events.

The identified paths of attack techniques represent kill chains. The present technique makes it possible to identify new kill chains of known techniques, as well as making it possible to identify high-risk kill chains.

It will be understood that not all multi-stage attacks can be defined by the same sequence of tactics. However, a particular sequence of tactics can often be applicable to (and thus be a generalisation of) several different multi-stage attacks, and so the ability to generalise is highly beneficial. It will be appreciated that a plurality of different sequences of tactics can be defined in the manner described herein, each sequence providing a generalisation of a different set of multi-stage attacks. The method is thus able to identify the occurrence of specific kill chains within a particular sequence of attack tactics, without advance knowledge of those kill chains.

The set of attack techniques represented by an attack tactic preferably have a common or similar purpose. In this sense the set of attack techniques are generally interchangeable, providing alternative routes to the same overall goal.

The method may comprise automatically generating a multi-stage attack detection and/or mitigation strategy for inclusion in an attack detection tool based on the identified path(s) of attack techniques. The detection tool may be a separate tool, or may be integrated with the software identifying the paths of attack techniques.

The attack detection strategy may be generated in dependence on a frequency of occurrence of the identified path(s) of attack techniques. For example, more frequent paths may be prioritised over less frequent paths.

The method may comprise identifying a frequency for each identified path of attack techniques through the sequence. In this way, the relative risk of different attack paths may be readily determined.

The method may comprise identifying a frequency with which attack events associated with a particular one of the techniques are detected. This makes it possible to identify which of the techniques represents the highest risk, particularly in the case where the techniques are easily interchangeable.

The detected attack events may be time stamped, and the linking of the detected attack events may comprise forming a time ordered chain of linked attack events.

The method may comprise identifying, from the linked detected attack events, one or more attack techniques having a high likelihood of progression to a subsequent attack tactic in the sequence. In particular, some of the techniques in earlier stages in the sequence of tactics may represent dead ends, which do not progress onto later stages. It may be possible to ignore, or at least deprioritise, the detection and mitigation of such techniques since they have a low impact. In contrast, the method may comprise employing one or more mitigating measures for the attack techniques identified as having a high likelihood of progression to a subsequent attack tactic in the sequence, since these may represent the greatest risk.

The method may comprise adjusting the deployment of mitigation measures in dependence on trends or changes in the frequency of attack paths. That is, the frequencies of various attack paths may not be static, but may change over time, as attackers vary their approaches. The present invention may be able to identify such trends and changes, and take action accordingly.

The method may comprise identifying high risk attack paths and employing mitigation measures in relation to the identified high risk attack paths

The method may comprise identifying techniques which link with a high frequency to one or more techniques within a subsequent tactic in the sequence, and/or identifying techniques which link with a high frequency to one or more techniques within a preceding tactic in the sequence. Such techniques may represent beneficial targets for detection and mitigation, since upstream or downstream effects within the sequence of tactics may result.

According to a second aspect of the present invention, there is a provided a computer system including a processor and memory storing computer program code for performing the steps of the method set out above.

The attack paths may be weighted in dependence on a frequency with which those attack paths occur, and mitigation measures may be selectively employed in dependence on these weightings.

Embodiments of the present invention will now be described, by way of example only, with reference to the accompanying drawings, in which:

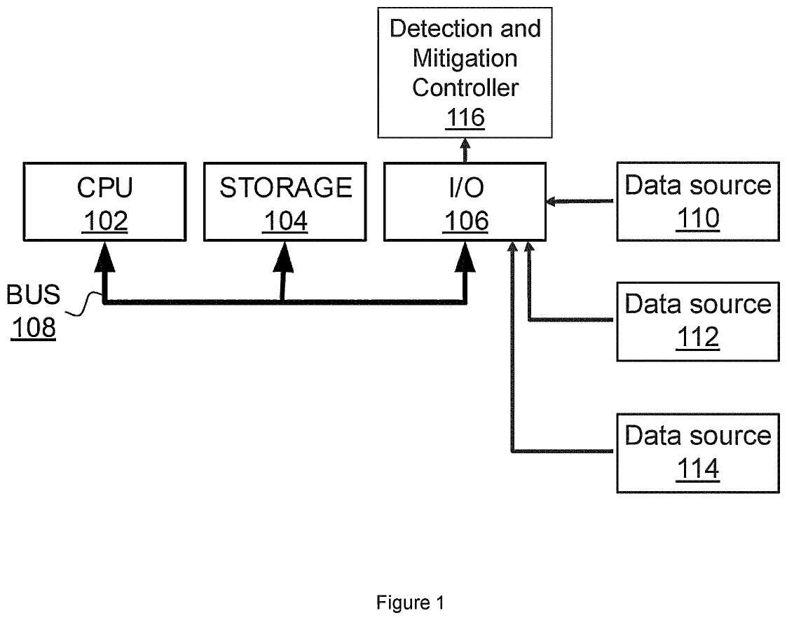

FIG. 1 is a block diagram of a computer system suitable for the operation of embodiments of the present invention;

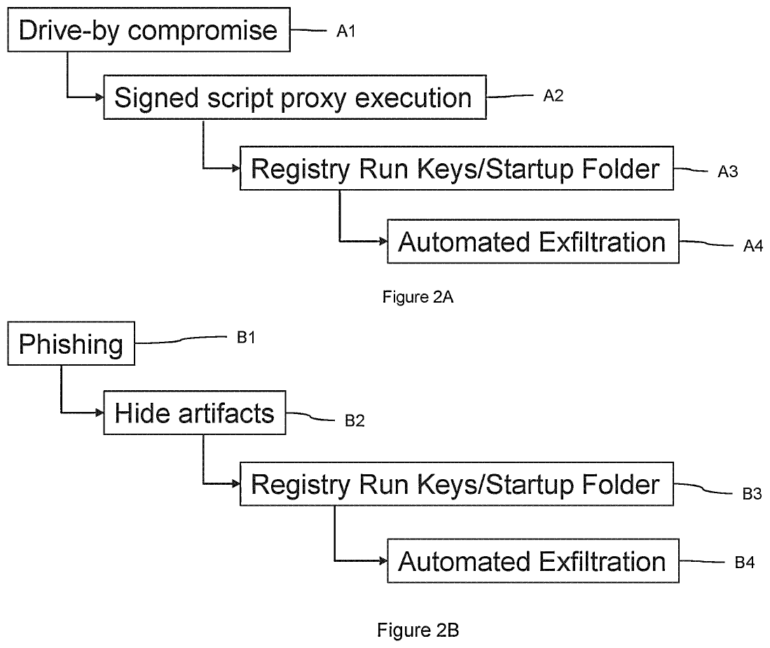

FIGS. 2A and 2B schematically illustrates two alternative kill chains;

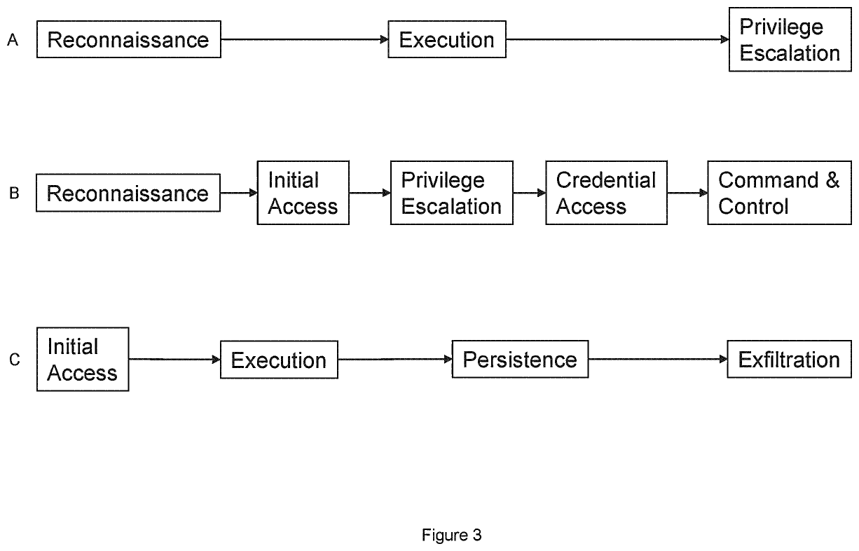

FIG. 3 schematically illustrates three different sequences of attack tactics, each representing a generalisation of related or analogous attack techniques;

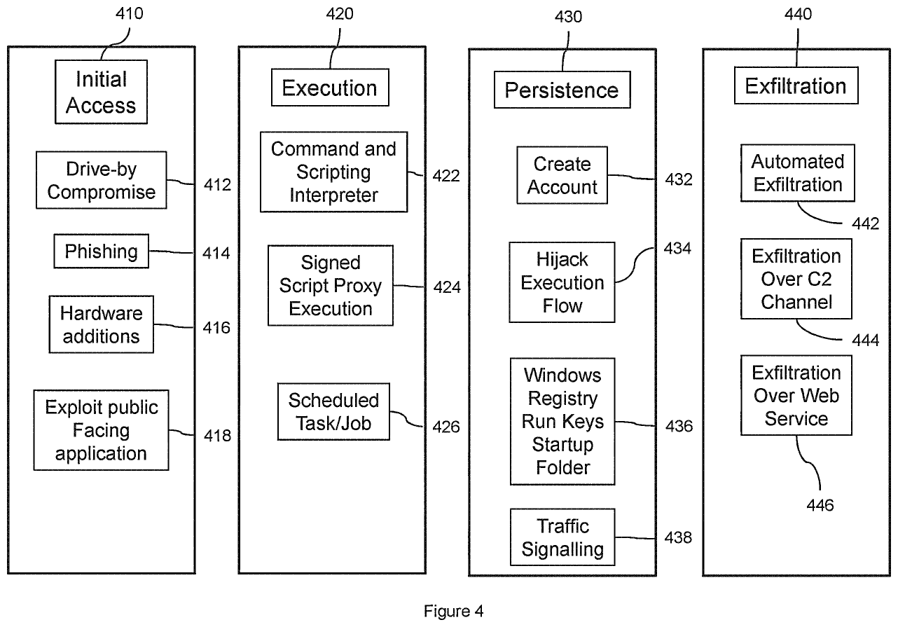

FIG. 4 schematically illustrates an example relationship between attack techniques and attack tactics, for example C of FIG. 3;

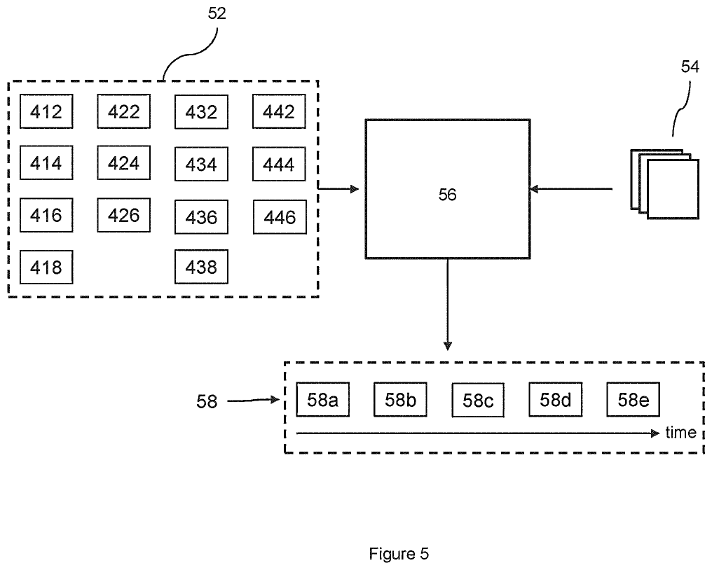

FIG. 5 schematically illustrates a process for detecting attack events from a system or network log using detection rules for the various attack techniques;

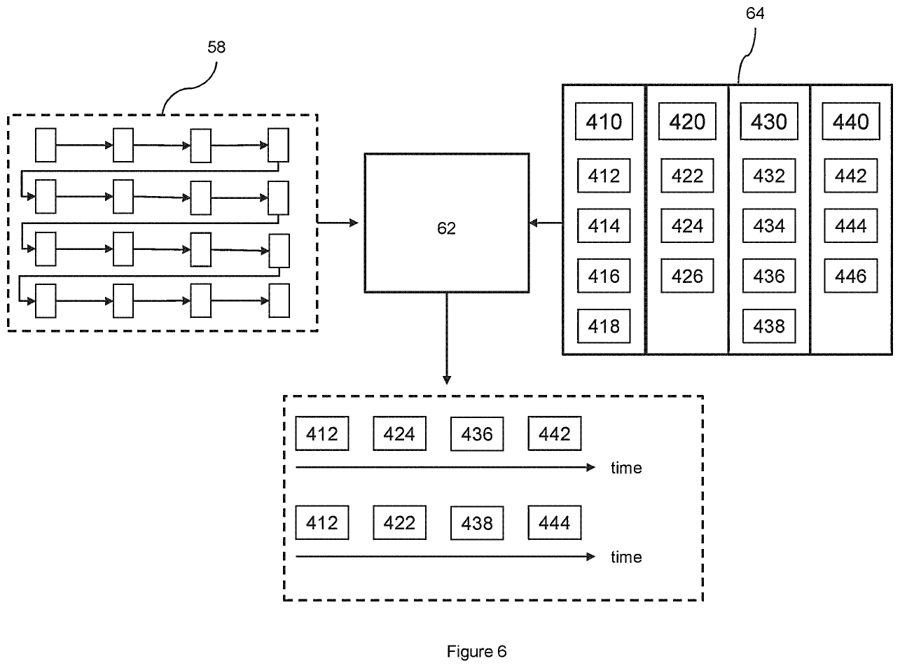

FIG. 6 schematically illustrates a process for forming the detected attack events into kill chains, each representing a path of techniques through a sequence of tactics;

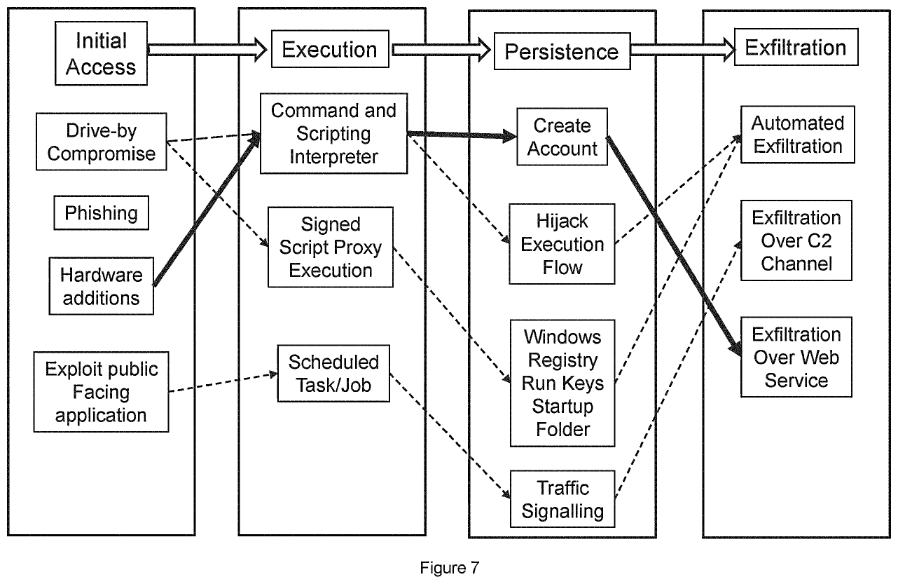

FIG. 7 schematically illustrates a detected high frequency kill chain through the sequence of tactics;

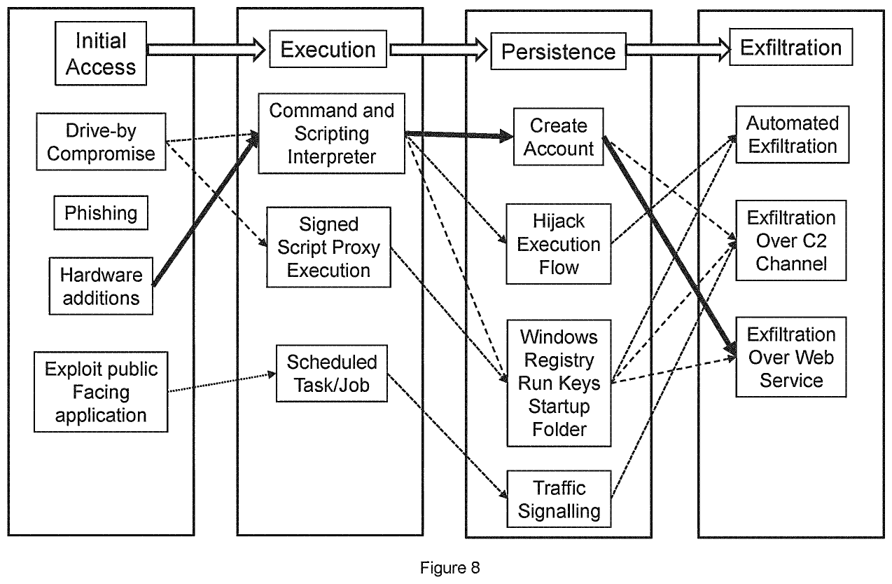

FIG. 8 schematically illustrates differently weighted paths or kill chains through the sequence of tactics; and

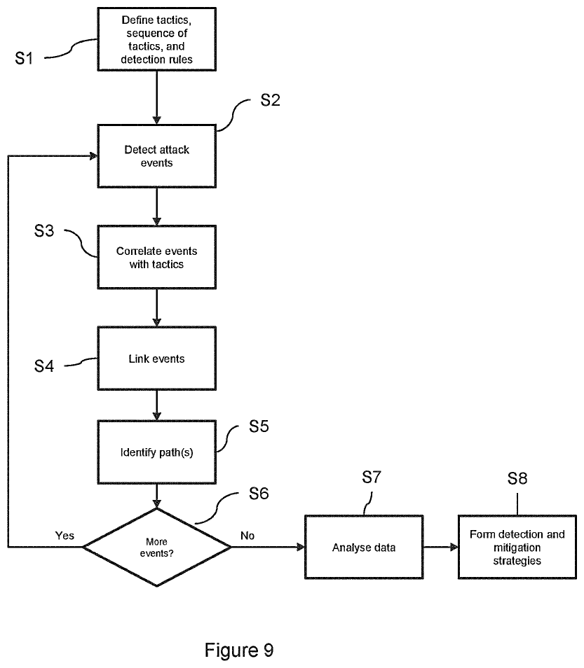

FIG. 9 is a schematic flow diagram representing a high level operation of embodiments of the present invention.

Referring to FIG. 1, a computer system is shown in which a central processor unit (CPU) 102 is communicatively connected to a storage 104 and an input/output (1/O) interface 106 via a data bus 108. The storage 104 can be any read/write storage device such as a random-access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection. For the present technique the I/O interface 106 is shown to be operatively connected to receive data from several external data sources 110, 112, 114, each of which generates events and provides them to the computer system. The events may be of a variety of different types, and may either be detected in real time, as they occur on a computer system or network, or may be extracted from a data log. These events may be representative of parts of a multi-stage attack. The I/O interface 106 is also operatively connected to provide data to a detection and mitigation controller 116, which may be provided on a separate computer system. Alternatively, the detection and mitigation controller 16 may be part of the computer system of FIG. 1.

Functionally, the computer system implements several functions directed to detecting, and mitigating, multi-stage “cyber attacks” (used here as a general term to cover such activities as denial of service (DOS), including Distributed Denial of Service (DDOS), attacks and attempts to infect target computer devices with malicious software—e.g. as part of a DOS attack or simply in order to steal information—e.g. credit card details of customers—etc.).

Although there are known monitors for detecting known signatures of malicious traffic and/or activities at various different detectors associated with various different typical stages of a multi-stage cyber-attack, it is often difficult to detect a sophisticated multi-stage attack from the use of a single monitor alone (or even multiple different monitors acting in isolation). Instead, such sophisticated multi-stage attacks can often only successfully be detected by linking various different activities (generally detected by different detectors) together and examining them together as aspects of a single multistage attack.

Multi-stage attacks can often defeat individual point checks and can only be detected by linking and examining together the various different stages of the attack. For example, login failures are quite common and unlikely to result in a major security incident. However, login failures, followed by a successful login, and obtaining admin rights (by a malicious unauthorised user), and then installing (malicious) software and then observing abnormal traffic flowing over the network is very likely in total to be indicative of a successful attack. All of these types of events (and others) may be logged, and used in the present technique in the detection of attack events.

Various approaches for either automatically or semi-automatically identifying attacks by looking for these distinct multiple stages of attack have been proposed and a selection of such proposals is set out below: “Multi-stage Intrusion Detection System Using Hidden Markov Model (HMM) Algorithm” by Do-hyeon Lee, Doo-young Kim, Jae-il Jung (2008 International Conference on Information Science and Security), “Applications of Hidden Markov Models to Detecting Multi-stage Network Attacks” by Ourston et al. (Proceedings of the 36th Hawaii International Conference on System Sciences—2003), “Automatic attack scenario discovering based on a new alert correlation method” by AN Ebrahimi et al (Systems Conference (SYSCON), 2011 IEEE International, IEEE, 4 Apr. 2011, pages 52-58), “Addressing Low Base Rates in Intrusion Detection via Uncertainty-Bounding Multi-Step Analysis” by Robert Cole and Peng Liu (Computer Security Applications Conference 2008 (ACSAC 2008) Annual, IEEE, Piscataway, NJ, USA, 8 Dec. 2008 pages 269-278), “An analysis Approach for Multi-stage Network Attacks”.

The above methods, along with those proposed in EP2979424, may be used to identify attacks, but their effectiveness is only as good as the attack graphs (sequences of techniques) upon which they are based. The present technique seeks to improve on this.

The present technique proposes an automated cyber-defence system that makes use of the knowledge of (predicted) attack paths to systematically detect and correlate the steps in a particular order that may eventually lead to a serious security breach. An example attack path for detecting data exfiltration attack is shown in FIG. 2A. The attack steps or techniques to be detected by the cyber-defence system are specified in the following (chronological) order:

A1. Drive-by Compromise: The attacker is trying to gain access to a system by misleading a user to a malicious website over the normal course of browsing.

A2. Signed Script Proxy Execution: The attacker is trying to avoid being detected by using scripts signed with trusted certificates to proxy execution of malicious files.

A3. Registry Run Keys/Startup Folder: The attacker is trying to maintain their foothold by adding a program to a startup folder or referencing it with a Registry run key.

A4. Data Exfiltration: The attacker is trying to steal or exfiltrate data such as sensitive documents through the use of automated processing.

Conventionally, such an attack path is manually specified/defined by a cyber-defence expert based on known TTP (Tactics, Techniques and Procedures) combined with the expert's experience and intimate knowledge of the network in question. However, in practice the attacker may also employ different techniques for some or any of the steps to achieve the same final objective, that is, to steal sensitive information. The chosen attack paths depend on the attackers' own resources and capabilities as well as the set of conditions of the victim network (e.g. size and configuration of the network, who is using the network, who is the network admin, etc.). For example, instead of using “Drive-by Compromise” technique the attacker may send phishing emails to specific individuals who have access to the network. Instead of using “Signed Script Proxy Execution” technique the attacker may attempt to hide artifacts associated with their behaviours.

FIG. 2B shows an example of such alternative attack path that may still lead to data exfiltration:

B1. Phishing: The attacker masquerades as a trusted entity, and elicits the opening of an email or other message, thereby gaining access to a system

B2. Hide artifacts: The attacker is trying to avoid being detected by hiding a malicious file as a “hidden file” within the Operating System for subsequent execution.

B3. Registry Run Keys/Startup Folder: Identical to A3 from FIG. 2A

B4. Data Exfiltration: Identical to A4 from FIG. 2A.

If the alternative attack path shown in FIG. 2B is not specified by the cyber-defence analyst/expert (only the attack path of FIG. 2A), the whole attack might successfully bypass a detection or might be detected too late.

Although the techniques used in the first two steps of the attack paths of FIGS. 2A and 2B are different they still share the same objectives. The techniques in the first step (A1 and B1) should allow the attacker gain initial access to the network and the ones in the second step (A2 and B2) aim to hide the implanted malware from detection. Basically, a set of attack techniques can be generalised into a single attack tactic if they serve the same purpose. All the above-mentioned techniques can be categorised to the following attack tactics:
Initial Access (tactic): Drive-by Compromise, Phishing (techniques)
Defense Evasion (tactic): Signed Script Proxy Execution, Hide Artifacts (techniques)
Persistence (tactic): Registry Run Keys/Startup Folder (technique)
Exfiltration (tactic): Automated Exfiltration (technique)

The present invention utilises a pre-defined knowledge base in the automated cyber-defence system to identify the attack tactics and their associated attack techniques. MITRE ATT&CK® is an example of such knowledge base which is created through real-world observations. The main attack paths that will be manually defined by the cyber experts and used by the system to detect (multi-stage) attacks will thus consist of a sequence of the attack tactics (instead of the specific attack techniques). FIG. 3 shows an example of three attack paths, which may each be considered a graph of tactics.

A first attack path A comprises three tactics, in sequence, these being “Reconnaissance”, “Execution” and “Privilege Escalation”. A second attack path B comprises five tactics, in sequence, these being “Reconnaissance”, “Initial Access”, “Privilege Execution”, “Credential Access” and “Command and Control”. A third attack path C comprises four tactics, in sequence, these being “Initial Access”, “Execution”, “Persistence” and “Exfiltration”. Each of these attack paths represents a generalisation of sequences of specific techniques. Further attack paths may be defined representing generalisations of other sequences of techniques.

In FIG. 4, the attack path C of FIG. 3 is shown, in which (some of) the attack techniques associated to each tactic are set out. In particular, the tactic “Initial Access” 410 can be seen to be a generalisation of “Drive by compromise” 412, “Phishing” 414, “Hardware additions” 416 and “Exploit public-facing application” 418. The tactic “Execution” 420 can be seen to be a generalisation of “Command and scripting interpreter” 422, “Signed script proxy execution” 424 and “scheduled task/job” 426. The tactic “Persistence” 430 can be seen to be a generalisation of “Create Account” 432, “Hijack execution flow” 434, “Windows registry run keys startup folder” 436 and “Traffic signalling” 438. The tactic “Exfiltration” 440 can be seen to be a generalisation of “Automated exfiltration” 442, “Exfiltration over C2 channel” 444 and “Exfiltration over web service” 446.

The cyber-defence system assigns an attack detection rule to each of the specified attack techniques. Subsequently, when processing security logs and network/system events the system correlates the logs/events with the attack detection rules in order to produce attack events or alerts each of which can identify the specific technique used by the attacker (that has led to the observed event). All of these attack alerts will normally be generated in chronological order according to the events' timestamps. This process is illustrated in FIG. 5. In FIG. 5, attack detection rules 52 are provided for each of the techniques 412, 414, 416, 418, 422, 424, 426, 432, 434, 436, 438, 442, 444, 446. These may be stored in a database or other memory structure. The rules may be modified or adjusted over time if required to improve detection of events indicative of the techniques. Network/system events 54 are monitored and logged. A correlator 56 correlates the logged events 54 with the attack detection rules 52, to generate technique-specific attack events/alerts. As shown in FIG. 5, these may be time-ordered, based on time stamps associated with the logged network/system events 54. In the example, five events have been identified as relating to (or being indicative of) one of the attack techniques for which the rules 52 are set. These identified events are 58a, 58b, 58c, 58d and 58e, and are shown as time-order on a time axis T. In this example, the event 58a is indicative of a “drive-by compromise” 412 technique, the event 58b is indicative of a “Create account” technique 432, the event 58c is indicative of a “Command and scripting interpreter” technique 422, the event 58d is indicative of an “Automated exfiltration” technique 442 and the event 58e is indicative of an “Exfiltration over C2 channel” technique 444. In practice a much larger number of events is likely to be output by the correlator 56, with events from multiple techniques for each (or at least some) of the tactics.

Referring to FIG. 6, the generated attack events/alerts 58 are then inputted into an alert correlation engine (ACE) 62 for further processing. The main attack paths (graph of tactics) that were defined by the cyber experts (for example the three paths A, B and C shown in FIG. 3) will be used by the ACE 62 to correlate and link the attack events/alerts based on specific criteria. The so-linked events represent a kill chain. Various criteria may be used, such as linking events sharing the same destination IP address or hostname (and which are therefore likely to relate to the same attack, and thus the same kill chain). The events are linked chronologically (or at least in a time-ordered fashion) following the order or sequence defined in the main attack paths. Since each attack event has been associated with an attack technique (by virtue of its detection by the technique-specific rules as discussed with reference to FIG. 5) the ACE 62 will be able to identify a number of kill-chain variations or paths of attack techniques, as shown in FIG. 6. In the example of FIG. 6, two separate kill chains are shown (in practice there may be others, but only two are shown in the interest of simplicity). The first kill chain comprises a “drive by compromise” 412 followed by a “Signed script proxy execution” 424, followed by a “Windows registry run keys startup folder” 436, followed finally by a “Automated exfiltration” 442. The second kill chain comprises a “drive by compromise” 412 followed by a “Command and Scripting interpreter” 422, followed by a “Traffic signalling” 438, followed finally by an “Infiltration over C2 channel” 444. Both of these kill chains follow the same four sequence of tactics, but each relies on different techniques in at least one of the tactics. The system is able to automatically extract sequences of tactics in this way, without these sequences being known in advance. Instead, the generalisation (tactics) are known in advance, and so provided an association between techniques and tactics is known, and that rules for detecting the use of techniques can be defined, then actual sequences of techniques may be identified automatically.

After the whole process is executed against a multitude of data (system/network events) over a period of time, the system can eventually identify high-frequency paths constituting most prolific, common or frequent attacks. FIG. 7 illustrates this by showing each detected sequence of techniques by way of arrows joining each stage (tactic), with the most prolific sequence of techniques being indicated by solid arrow, and the less prolific sequences being indicated by dashed arrows.

High-frequency attack paths can then be presented back to the cyber experts who are able to analyse the associated attack techniques and develop the most suitable actions and measures to mitigate the attacks. Such mitigation measures may strongly depend on the configuration of the network as well as the presence/availability of specific security appliances and tools (e.g. Firewall, DDoS prevention software, etc.). The identified (high frequency) attack paths can then be converted to attack graphs for inclusion in an attack graph detection tool, via which the cyber experts can specify when (i.e. after which steps/stages of the attack path) to raise high-priority alerts/incidents in order to break the kill-chain and prevent the attack progressing further into the final stages. Each alert may then trigger manual and automated (pre-defined) mitigation actions.

Each high-frequency attack path (i.e. attack graph) can be further enriched with branches of alternative techniques for each stage/tactic. Based on the outcomes of the attack alert correlation process shown in FIG. 6 the (branched) techniques can be weighted according to their statistical distributions. The attack graph detection tool can use the weightings to better predict how an attack may progress next while at the same time providing useful information to security analysts about possible deviations from the “main” attack path. FIG. 8 shows an example of such weightings for an attack graph. In FIG. 8, the dotted arrows indicate secondary (low frequency) attack paths, the solid arrows indicate the main attack path, while the dashed arrows indicate branches of the main attack path. In particular, the main attack path from the first stage (“Initial Access”) to the second stage (“Execution”) branches from the second stage to the third stage (“Persistence”), where one (highest frequency) path uses the “Create account” technique, while another (lower frequency) path uses the “Windows registry run keys startup folder” technique. From the third stage to the fourth stage (“Exfiltration”), two branches are defined from each of the “Create Account” technique and the “Windows registry run keys startup folder” technique to techniques of the fourth stage. In this example, both branches from each of these two stage 3 techniques lead to the same two techniques of the fourth stage, these being “Exfiltration over web service” and “Exfiltration over C2 channel”. From this, it can be understood that some of the techniques within the intermediate tactics are being used generally interchangeably to reach the final stage(s), along with multiple techniques from the final stage being used. The generalisation provided by the attack tactics definitions make it possible to discern patterns in the techniques being used.

The resulting data can be used in a wide variety of ways to enhance the detection of and mitigation against multi-stage attacks.

As described above, new and/or high-frequency attack paths can be identified automatically. Once identified, these can be converted to attack graphs for inclusion in an attack graph detection tool. This removes the requirement to carry out time-consuming tasks to create the attack graphs manually.

Trends and changes in the most prolific attack paths can be observed automatically and reflected in the adjustment of the associated attack graphs. This may facilitate the maintenance of up-to-date attack graphs included in the detection tool. For example, new attack graphs can be added for attack paths which are becoming more common, while attack graphs relating to attack paths which are becoming less frequent may be removed. More aggressive mitigation measures (which may be costly in terms of system or network resources) may be applied to combat attack paths which are frequent, or becoming more common, while less aggressive mitigation measures may be applied to less frequent attack paths.

More generally, suitable mitigation measures can be developed and focused on the most serious attack paths to allow taking pro-active actions for better network protection. It is also possible to reduce the number of mitigations deployed to an attacked system (because attack paths which are rarely, or never, used may in some cases be ignored).

Useful insights can be extracted from the observed attack paths to better understand how and why certain attack techniques may or may not have succeeded. In a multi-customer cyber-defence system (e.g. managed security services) this knowledge can be used to provide ready-made mitigation approach and attack paths for customers' systems/networks having similar configurations.

Attack paths may progress differently within different customers' networks, due to differences in hardware, software, settings etc. While an attack technique may have succeeded in one customer's network, it may not have the same effect on another customer's network. This insight can be used to identify vulnerabilities in the affected customer's network and recommend remediation measures.

For example, based on collected data from multiple systems or network, the present technique may identify that a particular system or network is vulnerable to a particular sequence of attack tactics, or a sequence of attack techniques. This may be detected due to a relatively high frequency of particular tactics or techniques compared with other systems or networks. The nature of the vulnerability may be derived or inferred from the specific tactics or techniques which the system or network is vulnerable to. Action may then be taken to modify the network or system to mitigate the vulnerability. In the case where a particular system or network is identified as vulnerable to particular techniques within a tactic, or to a particular sequence of techniques (attack chain), particular mitigation measures may be implemented which are directed to those techniques.

In one implementation, the above may be achieved by identifying a relationship between frequency of attack paths and system or network configuration, and selecting mitigation measures in dependence on system and/or network configuration.

Over time, the system can learn that certain attack techniques (within a tactic) could not progress to the next stage (tactic) and can therefore be less prioritised or ignored completely to reduce the workload of security analysts. Detection rules associated with the techniques can be removed from the system to reduce the number of alerts (tickets) and free up system resources.

Various other types of analysis may also be carried out, in addition to the identification of new kill chains, and the determination of frequencies or weightings for particular kill chains. For example, rarely used attack chains may be detected (based on a low frequency of occurrence), and deprioritized. Frequently interchanged techniques (within the same tactic) may be identified, and both techniques monitored for and/or mitigated. Techniques which most frequently progress onto the next stage can be identified, and targeted to benefit from the downstream effect on the kill chain. Techniques which are progressed onto frequently from multiple early stage techniques, representing later stage bottlenecks, can be identified and targeted. In other words, by mitigating downstream, this may render useless the earlier attack techniques leading into the mitigated technique, and by mitigating upstream, attacks may be caught early to minimise system/network impact, and to reduce the necessity to mitigate downstream.

FIG. 9 is a schematic flow diagram illustrating the steps involved in one embodiment of the invention. At a step S1, the tactics (that is, which techniques can be generalised into which tactics), the sequence of tactics, and detection rules for each technique are defined. The detection rules for the rules are similar to those applied in existing techniques, and are known to the person skilled in the art. At a step S2, attack events are detected, by correlating system or network events with the detection rules defined in the step S1. At a step S3, the attack events detected at the step S2 are correlating with the tactics, based on an association between the techniques to which the relevant detection rule related and the corresponding tactic. At a step S4 the attack events are linked together based on a parameter such as destination IP address or hostname. At this stage the linked events may also be time-ordered, based on time stamps of the events. At a step S5, one or more paths (of techniques) through the sequence of tactics are generated, representing a kill chain. At a step S6, it is determined whether there are any further events (in a system or network log being interrogated). If so, the process returns to the step S2 to process more event data. If not, the process progresses to a step S7, where the data, most particularly the identified paths, is analysed. Based on the analysed data, at a step S8 one or more detection and/or mitigation strategies are formed, for example by generating an attack graph for use by an attack detection tool.

By way of summary of the above, attack paths are defined at a granular level consisting of a graph of individual techniques utilised by an attacker to achieve their attack. Techniques are attributed to tactics (generalisations of techniques) and techniques within a tactic are conceivably interchangeable. Embodiments of the invention involve the pre-definition of a “graph of tactics” (a generalisation of attack paths) employed to exploit a vulnerability or otherwise effect an attack. A correlation database of techniques to tactics is used to categorise individual techniques to tactics (e.g. event information indicative of a technique can be used). Over time, paths between individual techniques to constitute attacks according to the tactics graph are analysed to identify high-frequency paths constituting most prolific, common or frequent attacks. Those high-frequency paths are then converted to attack graphs for inclusion in an attack graph detection tool. Mitigative measures are then deployed via the tool for each defined attack path, each measure corresponding to those identified prolific paths so achieving the benefit of: focusing mitigation measures on the most serious attack path; providing ready-made mitigation approach and attack paths for systems having similar configurations; and reducing a number of mitigations deployed to an attacked system.

Insofar as embodiments of the invention described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present invention. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilises the program or a part thereof to configure it for operation. The computer program may be supplied from a remote source embodied in a communications medium such as an electronic signal, radio frequency carrier wave or optical carrier wave. Such carrier media are also envisaged as aspects of the present invention.

It will be understood by those skilled in the art that, although the present invention has been described in relation to the above described example embodiments, the invention is not limited thereto and that there are many possible variations and modifications which fall within the scope of the invention.

The scope of the present invention includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented security method for detecting attacks on a system or network, the method comprising:
defining a sequence of attack tactics, each attack tactic representing a generalisation of a set of attack techniques;
associating one or more attack detection rules with each of the attack techniques;
detecting attack events based on the attack detection rules;
correlating the detected attack events with the attack tactics based on the attack technique associated with the attack detection rule used to detect the attack events;
linking the detected attack events based on one or more criteria; and
identifying one or more paths of attack techniques through the sequence in dependence on the linked attack events.

2. A method according to claim 1, wherein the set of attack techniques represented by an attack tactic have a common or similar purpose.

3. A method according to claim 1, comprising automatically generating a multi-stage attack detection and/or mitigation strategy for inclusion in an attack detection tool based on the identified path(s) of attack techniques.

4. A method according to claim 3, wherein the attack detection strategy is generated in dependence on a frequency of occurrence of the identified path(s) of attack techniques.

5. A method according to claim 1, comprising identifying a frequency for each identified path of attack techniques through the sequence.

6. A method according to claim 1, comprising identifying a frequency with which attack events associated with a particular one of the techniques are detected.

7. A method according to claim 1, wherein the detected attack events are time stamped, and wherein the linking of the detected attack events comprises forming a time ordered chain of linked attack events.

8. A method according to claim 1, comprising identifying, from the linked detected attack events, one or more attack techniques having a high likelihood of progression to a subsequent attack tactic in the sequence.

9. A method according to claim 8, comprising employing one or more mitigating measures for the attack techniques identified as having a high likelihood of progression to a subsequent attack tactic in the sequence.

10. A method according to claim 1, comprising adjusting the deployment of mitigation measures in dependence on trends or changes in the frequency of attack paths.

11. A method according to claim 1, comprising identifying high risk attack paths and employing mitigation measures in relation to the identified high risk attack paths

12. A method according to claim 1, comprising identifying techniques which link with a high frequency to one or more techniques within a subsequent tactic in the sequence, and/or identifying techniques which link with a high frequency to one or more techniques within a preceding tactic in the sequence.

13. A computer system including a processor and memory storing computer program code for performing the steps of the method of claim 1.

14. A computer program element comprising computer program code to, when loaded into a computer system and executed thereon, cause the computer to perform the steps of a method as claimed in claim 1.
